(19) United States
(12) Patent Application Publication
(10) Pub. No.: US 2026/0178978 A1
(43) Pub. Date: Jun. 25, 2026

(54) METHOD, APPARATUS AND SYSTEM FOR MACHINE LEARNING MODEL BASED ON ANALYSIS DATA SOURCE FEATURE

(71) Applicant: KOREA ELECTRONICS TECHNOLOGY INSTITUTE, Seongnam-si (KR)

(72) Inventor: Jong Bin PARK, Hwaseong-si (KR)

(21) Appl. No.: 19/427,845

(22) Filed: Dec. 19, 2025

(30) Foreign Application Priority Data
Dec. 24, 2024 (KR) 10-2024-0195335

(51) Int. Cl. G06N 20/00

(52) U.S. Cl. CPC G06N 20/00

(57) ABSTRACT

Proposed are a method, an apparatus, and a system for a machine learning model based on features of an analysis data source. The method may include determining a target distribution for a target data set. The method may also include determining a sample data set sampled from a reference data set based on the target distribution. The method may further include executing training for an analysis model based on the sample data set, and storing the trained analysis model in the memory.

### STATEMENT REGARDING GOVERNMENT SPONSORED R&D

This work was supported by Institute of Information & communications Technology Planning & Evaluation (IITP) grant funded by the Korea government(MSIT) (No. RS-2024-00337489, Development of data drift management technology to overcome performance degradation of AI analysis models)

### CROSS-REFERENCE TO RELATED APPLICATION

The present application claims priority under 35 U.S.C. § 119(a) to Korean patent application number 10-2024-0195335 filed on Dec. 24, 2024, in the Korean Intellectual Property Office, the entire disclosure of which is incorporated by reference herein.

### BACKGROUND

### Technical Field

The present disclosure relates to technologies associated with machine learning models, and more particularly, to technologies for providing and utilizing a machine learning model trained based on features of an analysis data source.

### Description of Related Technology

Hereinafter, a set of data, that is, a set of multiple data items, may also be referred to as a “data set”.

A machine learning model (hereinafter referred to as “model”) is trained based on a training data set and, after being trained, may receive target data serving as input for inference by inputting the target data into the trained model, and may thereby obtain output data (hereinafter referred to as “analysis data”) representing inference results for the target data (that is, analysis result).

### SUMMARY

One aspect is to provide a technology for providing and utilizing a machine learning model trained based on features of analysis data sources.

Another aspect is to provide a technology for training, providing, and utilizing a model suitable for an actual service field by using features of analysis data sources that occur in the actual service field (that is, data distribution information of target data).

Another aspect is to provide a technology capable of being processed even on computers having relatively low computing capability by addressing data drift with a small amount of computation.

The aspects are not limited to those described herein, and other aspects not mentioned will be clearly understood by those of ordinary skill in the art from the following description.

Another aspect is a method performed in a system comprising at least one memory and at least one processor, and the method may include determining a target distribution for a target data set, wherein the target distribution represents data distribution features of the target data set; determining a sample data set sampled from a reference data set based on the target distribution; performing training of an analysis model based on the sample data set; and storing the trained analysis model in the memory.

In an exemplary embodiment of the present disclosure, the system may include a first device and a second device, and the method may further include determining, by the first device, the target distribution and providing distribution features determined thereby to the second device; and training, by the second device, the analysis model based on the target distribution, and providing the trained analysis model stored therein to the first device.

In an exemplary embodiment of the present disclosure, the first device may have relatively higher computational processing capability than the second device.

In an exemplary embodiment of the present disclosure, the determining the target distribution may include generating a representation vector for each target data item; reducing a dimensionality of each generated representation vector; and identifying the target distribution using the dimensionally reduced representation vectors.

In an exemplary embodiment of the present disclosure, the executing training of the analysis model may include generating a representation vector for each reference data item; reducing a dimension of each generated representation vector by using a reference dimensionality reduction model; and sampling data corresponding to selected representation vectors among the dimensionally reduced representation vectors as the sample data.

In an exemplary embodiment of the present disclosure, the executing training of the analysis model further include identifying a reference distribution, which is a data distribution of the reference data set, by using each of the dimensionally reduced representation vectors; and sampling the sample data based on a comparison between the identified reference distribution and the prepared target distribution.

In an exemplary embodiment of the present disclosure, the determining the target distribution may include generating a representation vector for each target data item; and reducing a dimension of each generated representation vector by using a target dimensionality reduction model, and identifying the target distribution by using each of the dimensionally reduced representation vectors, and the target dimensionality reduction model and the reference dimensionality reduction model may have identical parameters.

In an exemplary embodiment of the present disclosure, the method may further include transmitting, by the first device, the target dimensionality reduction model to the second device, and the reference dimensionality reduction model may reuse the target dimensionality reduction model.

In an exemplary embodiment of the present disclosure, the target dimensionality reduction model and the reference dimensionality reduction model may be implemented using a linear method or a nonlinear method, or be implemented using a combination of a linear method and a nonlinear method.

In an exemplary embodiment of the present disclosure, the target distribution may be expressed in the form of a probability density function (PDF) or a probability mass function (PMF).

In an exemplary embodiment of the present disclosure, the reference distribution and the target distribution may each be expressed in the same form.

In an exemplary embodiment of the present disclosure, the sampling may include preparing a probability density function for the target distribution based on kernel density estimation (KDE); and sampling the sample data from the probability density function using inverse transform sampling or rejection sampling.

In an exemplary embodiment of the present disclosure, the sampling may include preparing a histogram and probability values for respective bins based on a probability mass function (PMF); generating a cumulative distribution function (CDF) by cumulatively summing the probability values of the respective bins of the PMF; and sampling the sample data at a center position or a random position within a bin corresponding to a random variable generated according to a uniform distribution from the CDF.

In an exemplary embodiment of the present disclosure, the sampling may include comparing the reference distribution and the target distribution to identify a region in which only reference data exist in a number equal to or greater than a predetermined number, or in which target data exist at a ratio equal to or greater than a predetermined ratio relative to the reference data; and sampling the sample data from the identified region.

Another aspect is an apparatus that may include at least one memory storing a plurality of instructions and an analysis model; and a processor configured to execute the plurality of instructions, and the processor may be configured to: determine a target distribution for a target data set, the target distribution being data distribution features of the target data set; determine a sample data set sampled from a reference data set based on the target distribution; execute training of the analysis model based on the sample data set; and store the trained analysis model in the memory.

In an exemplary embodiment of the present disclosure, during the training, the processor may generate a representation vector for each reference data item; reduce a dimension of each generated representation vector; and sample, as the sample data, data corresponding to selected representation vectors among the dimensionally reduced representation vectors.

In an exemplary embodiment of the present disclosure, during the sampling, the processor may prepare a probability density function for the target distribution based on kernel density estimation (KDE); and perform sampling of the sample data from the probability density function by using inverse transform sampling or rejection sampling.

In an exemplary embodiment of the present disclosure, during the sampling, the processor may prepare a histogram and probability values for respective bins based on a probability mass function (PMF); generate a cumulative distribution function (CDF) by cumulatively summing the probability values of the respective bins of the PMF; and perform sampling of the sample data at a center position or a random position within a bin corresponding to a random variable generated according to a uniform distribution from the CDF.

In an exemplary embodiment of the present disclosure, during the sampling, the processor may identify a reference distribution, which is a data distribution of the reference data set, by using each dimensionally reduced representation vector; identify, by comparing the identified reference distribution with the target distribution, a region in which either reference data exist in a number greater than or equal to a predetermined number without corresponding target data, or target data exist at a ratio greater than or equal to a predetermined ratio relative to the reference data; and perform sampling of the sample data from the identified region.

Another aspect is a system that may include a first device including a first memory and a first processor; and a second device including a second memory and a second processor, and the first device may determine a target distribution for a target data set and store the determined target distribution in the first memory, the target distribution being data distribution features of the target data set; and provide the determined target distribution to the second device; and the second device may determine a sample data set sampled from a reference data set based on the target distribution; execute training of the analysis model based on the sample data set; and provide the trained analysis model to the first device.

The present disclosure configured as described above has an advantage in that it is capable of providing and utilizing a machine learning model trained based on features of an analysis data source.

That is, the present disclosure enables a model suitable for an actual service environment to be trained, provided, and utilized by using features of analysis data sources generated in the actual service environment (i.e., data distribution information of target data), thereby providing an advantage of effectively responding to data drift.

In addition, the present disclosure identifies a data distribution based on representation vectors and dimensionality reduction for each data set, and then trains a model by using new training data sampled in correspondence with the data distribution of the target data set. Accordingly, the present disclosure is capable of responding to data drift with a reduced amount of computation, and thus provides an advantage in that it can be processed even by a computer having relatively low computational processing capability.

In particular, the present disclosure has advantages in that it can address issues related to personal data protection as well as issues arising from differences in source features between reference data and target data.

The effects of the present disclosure are not limited to those mentioned above, and other effects not mentioned will be clearly understood by those of ordinary skill in the art from the following description.

### BRIEF DESCRIPTION OF THE DRAWINGS

FIG. 1 illustrates a schematic block diagram of a system 10 according to an exemplary embodiment of the present disclosure.

FIG. 2 illustrates a schematic block diagram of first and second devices 100 and 200.

FIG. 3 illustrates a flowchart of a method according to an exemplary embodiment of the present disclosure.

FIG. 4 illustrates a conceptual diagram of a method according to an exemplary embodiment of the present disclosure.

FIG. 5 illustrates a detailed flowchart for S210. FIG. 6 illustrates a conceptual diagram of processing performed by a second controller 250 of the second device 200.

FIG. 7 illustrates a detailed flowchart for S220.

FIG. 8 illustrates a conceptual diagram of processing performed by a first controller 150 of the first device 100.

### DETAILED DESCRIPTION

At this time, because the target data corresponds to data that serves as a source of the analysis data, it may also be referred to as an “analysis data source.” In addition, a set of target data may be referred to as a “target data set.” That is, a training data set is a set of training data used when training the model, and a target data set is a set of target data—i.e., analysis data sources—input for inference in an actual operating environment in which inference is performed using the model.

Meanwhile, a variety of analysis data sources that have not been used for training—that is, target data sets—are also the subject of extensive research in the machine learning field in order to provide high analysis (i.e., inference) performance for such data sources. Such research aims to develop a model with strong generalization capability, and securing sufficient and diverse training data for training is essential. However, in practice, securing such training data is very difficult, which consequently increases the cost required for the training itself.

Of course, even a model trained with substantial cost and time cannot satisfy all possible cases. For example, regardless of how diverse the training data used for training may be, entirely new types of analysis data sources may arise in the actual service environment where the model is deployed. Accordingly, the data distribution of the training data set used during the training process may differ from the data distribution of the analysis data sources that occur in the real service field, and this inevitably leads to degradation in the model's performance.

That is, in an actual service field, a problem of data drift may occur. Here, data drift refers to a phenomenon in which the data distribution of a target data set changes over time relative to the data distribution of a training data set, and it is one of the major causes of degradation in the model's performance.

Meanwhile, in the related art, machine learning was typically performed on computers or cloud servers equipped with high-performance computing capabilities, and processing to address data drift was also generally handled by such high-performance computers (hereinafter referred to as the “related art”). However, with the emergence and development of technologies such as federated learning, edge computing, and on-device AI, the need to perform processing for addressing data drift even on computers having relatively low computing capability has increased. Nevertheless, the related art has fundamental limitations in satisfying this need.

Hereinafter, specific embodiments according to exemplary embodiments of the present disclosure will be described with reference to the accompanying drawings. The following detailed description is provided to aid in a comprehensive understanding of the methods, apparatuses, and/or systems described herein. However, these are merely examples, and the present disclosure is not limited thereto.

In describing the exemplary embodiments of the present disclosure, detailed descriptions of well-known technologies related to the present disclosure will be omitted when it is determined that such descriptions may unnecessarily obscure the essence of the embodiments. The terms described below are defined in consideration of the functions of the present disclosure and may vary depending on the intention or custom of the user or operator, or other practices. Therefore, the definitions of the terms should be interpreted based on the overall contents of this specification. The terminology used in the detailed description is merely intended to describe exemplary embodiments and should not be interpreted as limiting. Unless clearly stated otherwise, expressions in the singular form include the plural form as well. In this description, expressions such as “comprise,” “include,” or “provide” are intended to indicate the presence or possibility of one or more characteristics, numbers, steps, operations, or elements, or combinations thereof, and should not be construed as excluding the presence or possibility of one or more other characteristics, numbers, steps, operations, or elements, or combinations thereof. In addition, terms such as “unit,” “device,” “module,” and “block,” as used in the present specification, refer to functional elements configured to perform at least one function or operation and may be implemented in hardware, in software, or in a combination of hardware and software.

Hereinafter, a preferred embodiment according to the present disclosure will be described in detail with reference to the accompanying drawings.

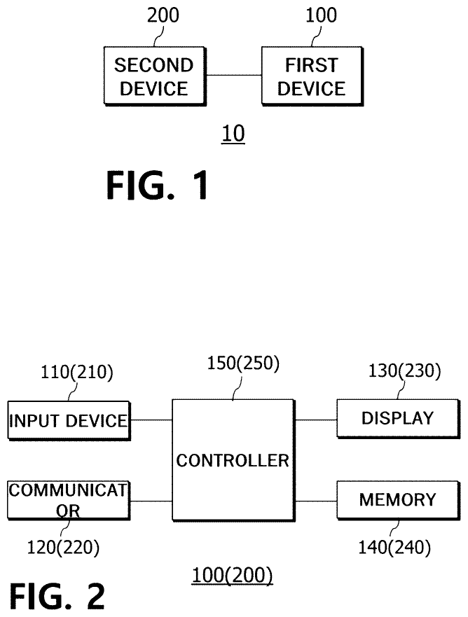

FIG. 1 illustrates a schematic block diagram of a system 10 according to an exemplary embodiment of the present disclosure.

A system 10 according to an exemplary embodiment of the present disclosure (hereinafter referred to as “the system”) is a system for training and inference of a machine learning model (hereinafter referred to as “analysis model”). The system 10 may perform a function of training—i.e., prior training or retraining—an analysis model and providing the trained model (hereinafter referred to as “a first function”), and may perform a function of performing inference—i.e., analysis—using an analysis model that has undergone prior training or retraining (hereinafter referred to as “a second function”). Based on these first and second functions, the system 10 is capable of responding to data drift.

Hereinafter, a set of data, that is, a set of multiple data items, may also be referred to as a “data set.” In particular, the analysis model may be pre-trained according to a machine learning technique based on a training data set, which is a set of training data.

With respect to the first function, the analysis model may be additionally retrained according to a machine learning technique based on a sample data set, which is a set of sample data described below. That is, the analysis model may already have been trained before the execution of the first function, and such training performed prior to the first function may be referred to as “prior training” in order to distinguish it from the retraining performed according to the first function.

Of course, retraining according to the first function may be performed multiple times at different points in time. In this case, retraining performed according to a previous execution of the first function and retraining performed according to a current execution of the first function may be respectively carried out. Here, the retraining performed according to the previous execution of the first function may be referred to as “prior training” in order to distinguish it from the retraining performed according to the current execution of the first function.

With respect to the second function, by inputting data serving as a target for inference (hereinafter referred to as “target data”) into the analysis model that has undergone prior training or retraining, output data (hereinafter referred to as “analysis data”) representing inference results (that is, analysis results) for the target data may be produced. Such target data may be data that is to be input into the analysis model for inference in the second device 200, and may accordingly be collected and stored in a second memory 240 of the second device 200.

In particular, because the target data corresponds to data that serves as a source of the analysis data, it may also be referred to as an “analysis data source.” In addition, a set of target data may be referred to as a “target data set.” For example, the target data set may be a data set that is input into the analysis model for inference in an actual operating environment in which inference is performed using the analysis model.

Meanwhile, in the present disclosure, a reference data set (hereinafter referred to as “reference data set”) is used in order to sample sample data. The reference data set may correspond to a large-scale data set including a plurality of reference data. Such a reference data set may be data that is to be input into the first device 100, and may accordingly be collected and stored in a first memory 140 of the first device 100.

Of course, the reference data set may include the training data set used during prior training. In this case, only the input data of the training data among the training data set (i.e., excluding the output data) may be used as the reference data.

Referring to FIG. 1, the system 10 may include a first device 100 and a second device 200. Various types of information may be transmitted and received between the first and second devices 100 and 200 through wired or wireless communication. In this case, with reference to the first device 100, the second device 200 corresponds to another device. Conversely, with reference to the second device 200, the first device 100 corresponds to another device.

In the system 10, the first device 100 is an electronic device for performing the first function. That is, the first device 100 corresponds to an electronic device for providing a pre-trained analysis model after retraining the model. In addition, in the system 10, the second device 200 is an electronic device for performing the second function. That is, the second device 200 corresponds to an electronic device for outputting analysis data (i.e., analysis results) by performing inference by inputting target data into the analysis model that has undergone prior training or retraining. However, either one of the first and second devices 100 and 200 may perform both the first function and the second function.

For example, the electronic device may be a general-purpose computing system such as a desktop personal computer, a laptop personal computer, a tablet personal computer, a netbook computer, a workstation, a smartphone, or a smartpad; a dedicated embedded system implemented based on Embedded Linux; or a cloud server system, but is not limited thereto.

FIG. 2 illustrates a schematic block diagram of first and second devices 100 and 200.

As shown in FIG. 2, the first and second devices 100 and 200 may include communicators 120 and 220, memories 140 and 240, and controllers 150 and 250. Of course, the first and second devices 100 and 200 may further include input devices 110 and 210 or displays 130 and 230.

Meanwhile, the training data set used during prior training of the analysis model may include a plurality of training data, each composed of a pair of input data and output data. The training data set is used to train the analysis model through the plurality of training data, and may be previously stored in the memory 240.

In addition, a retraining data set, which is a training data set used for retraining the analysis model, may include a plurality of retraining data, each composed of a pair of input data and output data. Here, the input data of the retraining data may include sample data described below, and the output data may include result data generated from the sample data. Such a retraining data set is used to retrain the analysis model through the plurality of retraining data, and may be previously stored in the memory 240.

The target data set includes a plurality of target data, each of which corresponds to input data that is to be input into the analysis model for inference, and may be previously stored in the memory 140.

In particular, the analysis model corresponds to a model that has undergone prior training or retraining according to a machine learning technique of supervised learning, unsupervised learning, or reinforcement learning through a training data set (or a retraining data set) in connection with various processing operations.

Specifically, the analysis model includes an input layer into which input data is to be input, an output layer from which output data is to be output, and a plurality of hidden layers provided between the input layer and the output layer. Accordingly, the relationship between the input data and the output data of a training data set (or retraining data set) is expressed through the plurality of hidden layers, and these hidden layers are also referred to as “representation layers” or a “neural network.” Therefore, the analysis model may represent the relationship between the input data and the output data of the training data (or retraining data) by using parameters such as weights and biases included in the plurality of hidden layers.

The analysis model that has undergone prior training or retraining may output, as output data, analysis data representing inference results (that is, analysis results) for the target data when the target data serving as input data for inference is input during inference, based on the preset parameters.

For example, in the training data set, the retraining data set, and the target data set, the input data may be in various formats such as an image, text, audio, video, or time-series data, but is not limited thereto.

For example, the machine learning technique applied to train the analysis model may include Artificial Neural Networks, Boosting, Bayesian Statistics, Decision Trees, Gaussian Process Regression, Nearest Neighbor Algorithms, Support Vector Machines, Random Forests, Symbolic Machine Learning, Ensembles of Classifiers, or Deep Learning, but is not limited thereto. In addition, the deep learning technique may include Deep Neural Networks (DNN), Convolutional Neural Networks (CNN), Recurrent Neural Networks (RNN), Restricted Boltzmann Machines (RBM), Deep Belief Networks (DBN), or Deep Q-Networks, but is not limited thereto.

The input devices 110 and 210 may generate input data in response to various user inputs and may include various types of input means. For example, the input devices 110 and 210 may include a keyboard, a keypad, a dome switch, a touch panel, a touch key, a touchpad, a mouse, a menu button, an audio input device, various types of sensor devices, or an imaging device, but are not limited thereto.

The communicators 120 and 220 are configured to perform communication with another device. For example, the first communicator 120 of the first device 100 may transmit information such as the data distribution (i.e., target distribution) for the target data set to be described below to the second communicator 220 of the second device 200. In addition, the first communicator 120 of the first device 100 may receive a dimensionality reduction model to be described below, an analysis model that has undergone prior training or retraining, or the like from the second communicator 220 of the second device 200. Of course, the communicator 120 of the first device 100 may transmit inference results (i.e., analysis results) or the like to another device, including but not limited to the second device 200.

For example, the communicators 120 and 220 may perform wireless communication such as cellular communication, LoRa communication, SigFox communication, 5G (5th generation communication), LTE-A (long term evolution-advanced), LTE (long term evolution), WiFi communication, or Bluetooth communication, or may perform wired communication using a UTP (Unshielded Twisted Pair) cable, a coaxial cable, an optical cable, or an HFC (Hybrid Fiber Coax) cable, but are not limited thereto.

The displays 130 and 230 may display various types of image data on a screen and may be configured as non-emissive panels or emissive panels. In this case, the displays 130 and 230 may display processes or results related to the execution of the first or second function. For example, the displays 130 and 230 may include a liquid crystal display (LCD), a light emitting diode (LED) display, an organic LED (OLED) display, a micro electro mechanical systems (MEMS) display, or an electronic paper display, but are not limited thereto. In addition, the displays 130 and 230 may be combined with the input devices 120 to be implemented as a touch screen or the like.

The memories 140 and 240 store various types of information necessary for operations of the first and second devices 100 and 200. The information stored in the first memory 140 of the first device 100 may include a target data set, a target distribution, a dimensionality reduction model, an analysis model, information received from another device, program information related to the method to be described below, and the like, but is not limited thereto. In addition, the information stored in the second memory 240 of the second device 200 may include a reference data set, a target distribution, a dimensionality reduction model, an analysis model, a retraining data set, information received from another device, program information related to the method to be described below, and the like, but is not limited thereto.

For example, the memories 140 and 240 may include volatile memory devices such as DRAM or SRAM; non-volatile memory devices such as PRAM, MRAM, ReRAM, or NAND flash memory; or storage devices such as a hard disk drive (HDD) or a solid-state drive (SSD), but are not limited thereto. In addition, the memories 140 and 240 may serve as a cache, a buffer, a main storage device, or an auxiliary storage device depending on their use or location, or may be implemented as a separately provided storage system, but are not limited thereto.

The controllers 150 and 250 may perform various control operations of the first and second devices 100 and 200. In particular, the first controller 150 of the first device 100 may control the execution of the first function, or the like, and the second controller 250 of the second device 200 may control the execution of the second function, or the like. To this end, the controllers 150 and 250 may control the execution of the method to be described below, and may also control operations of the remaining components of the first and second devices 100 and 200, such as the input devices 110 and 210, the communicators 120 and 220, the displays 130 and 230, and the memories 140 and 240.

The controllers 150 and 250 may include hardware such as a processor or software such as a process executed by the processor, but are not limited thereto. For example, the processor may include a microprocessor, a micro controller unit (MCU), a central processing unit (CPU), a processor core, a multiprocessor, an application-specific integrated circuit (ASIC), or a field programmable gate array (FPGA), but is not limited thereto.

Hereinafter, a method according to an exemplary embodiment of the present disclosure will be described in further detail.

A method according to an exemplary embodiment of the present disclosure (hereinafter referred to as “the method”) is a method performed in the system 10 and may be a method for providing and utilizing a model retrained based on features of analysis data sources. Such a method may correspond to a method for responding to data drift.

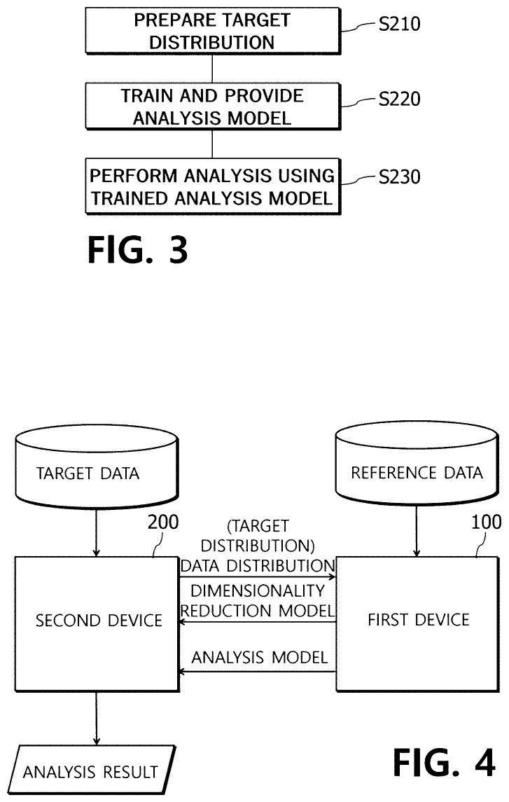

FIG. 3 illustrates a flowchart of a method according to an exemplary embodiment of the present disclosure and FIG. 4 illustrates a conceptual diagram of a method according to an exemplary embodiment of the present disclosure.

As shown in FIG. 3, the method may include S210 and S220. In this case, S210 and S220 may be performed under the control of the controllers 150 and 250. That is, the processors of the controllers 150 and 250 may process the execution of S210 to S230.

S210 is a step in which the second device 200 prepares (identifies) the data distribution of the target data set and provides (transmits) the data distribution to the first device 100.

That is, the second controller 250 may control the second device 200 to identify information on the data distribution of the target data set, which is stored in the second memory 240 (hereinafter also referred to as “target distribution”), and to transmit and provide the information to the first device 100 through the second communicator 220. Accordingly, the first controller 150 may control the first device 100 to store the received information on the target distribution in the first memory 140 through the first communicator 120.

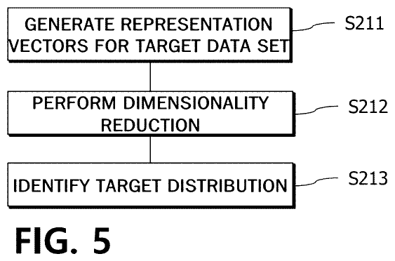

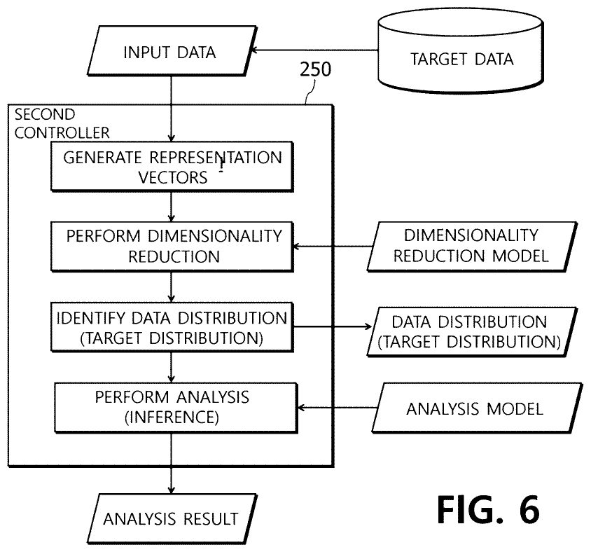

FIG. 5 illustrates a detailed flowchart for S210 and FIG. 6 illustrates a conceptual diagram of processing performed by a second controller 250 of the second device 200.

Referring to FIG. 5, S210 may include S211 to S213. That is, through S211 to S213, the target distribution is identified, stored in the memory 140, and may be transmitted to the first device 100 through the second communicator 220. Of course, referring to FIG. 6, S211 to S213 may be performed by the second controller 250. That is, the processor of the second controller 250 may process the execution of S211 to S213.

S211 is a step of generating representation vectors for the target data set.

That is, the second controller 250 may control the generation of a representation vector for each target data of the target data set. In this case, the second controller 250 may compute and generate a representation vector for each target data in the target data set.

Meanwhile, a representation vector, also referred to as an “embedding vector,” is a vector representation obtained by compressing high-dimensional original data into a lower-dimensional space, and may be used in fields such as machine learning. That is, a representation vector is a vector that represents high-dimensional original data as a vector in a lower dimension (i.e., a low-dimensional vector) and includes a meaningful representation of the corresponding original data.

In particular, a representation vector is useful when converting unstructured data such as text, images, or audio into numerical vectors that a machine learning model can understand and process. A representation vector compresses the characteristics of the original data while preserving important information, thereby enabling a machine learning model to more easily learn correlations or similarities.

In S211, various machine learning models (hereinafter referred to as “embedding models”) may be utilized to generate representation vectors. That is, an embedding model is a model trained to output a low-dimensional representation vector for high-dimensional original data (i.e., input data) when such original data is input. For example, the embedding model may be a model trained using various techniques such as an autoencoder, Word2Vec, GloVe, FastText, BERT, Doc2Vec, a CNN, CLIP, a Transformer, or a Vision Transformer.

S212 is a step of performing dimensionality reduction.

That is, S212 corresponds to a step of reducing the dimension of the representation vectors of the target data set, which are generated in S211, into a lower-dimensional space. Although a representation vector itself already reflects dimensionality reduction of the original data (i.e., the target data), mapping the representation vectors into an even lower-dimensional space through S212 may not only improve visualization or computational efficiency for the original data but also remove noise from the original data to better reveal important patterns.

In this case, dimensionality reduction for each representation vector may be performed using only a linear method, only a nonlinear method, or a combination of both a linear method and a nonlinear method.

A linear method refers to a method in which a linear relationship exists between a high-dimensional representation vector as input and a representation vector of reduced dimension (i.e., a low-dimensional vector) as output. For example, the linear method may desirably be a reusable linear reduction model such as Principal Component Analysis (PCA), Linear Discriminant Analysis (LDA), Singular Value Decomposition (SVD), a linear regression model, Linear Discriminant Analysis (LDA) for classification, or a linear Support Vector Machine (linear SVM), but is not limited thereto.

In this case, PCA has a fixed reduced principal component space obtained through principal component analysis, and thus dimensionality reduction can be performed for the representation vectors. LDA reduces the dimensionality by transforming the data in a direction that maximizes the variance between classes, and therefore the same projection may be applied to the representation vectors. SVD extracts major data features through singular value decomposition, and thus dimensionality reduction can be performed for the representation vectors using a fixed transformation matrix. A linear regression model learns regression coefficients and can therefore apply the same linear regression prediction to the representation vectors. Linear discriminant analysis, as a classification model, has a fixed learned decision boundary and can classify the representation vectors based on that decision boundary. A linear support vector machine learns a linear decision boundary and can classify the representation vectors using the fixed boundary.

A nonlinear method refers to a method in which a nonlinear relationship exists between a high-dimensional representation vector as input and a representation vector of reduced dimension (i.e., a low-dimensional vector) as output. For example, the nonlinear method may desirably be a reusable nonlinear reduction model such as Uniform Manifold Approximation and Projection (UMAP), an autoencoder, Kernel PCA, Isomap, or Locally Linear Embedding (LLE), but is not limited thereto. Additionally, although t-SNE (t-Distributed Stochastic Neighbor Embedding) is, in principle, a model difficult to reuse, it may be used in a limited manner by fixing the initial positions and projecting the points of the representation vectors accordingly.

Meanwhile, Independent Component Analysis (ICA) has a property in which valid results are produced only for the data used when training the model, making the model difficult to reuse. This issue arises from the nonlinear transformation method and data dependency of ICA, as ICA generally does not provide a fixed transformation matrix.

However, in S212, a dimensionality reduction model (hereinafter also referred to as a “target dimensionality reduction model”) may be used to perform dimensionality reduction on the representation vectors of the target data. Such a dimensionality reduction model may be one that has been trained in the first device 100 and received from the first device 100 through the second communicator 220.

S213 corresponds to a step of identifying information on a target distribution.

That is, S213 corresponds to a step of identifying information on a data distribution of the dimensionally reduced (i.e., lower-dimensional) representation vectors for the target data set (i.e., a target distribution).

Identifying the data distribution information may correspond to determining characteristics of the data distribution. For example, identifying the target distribution may be understood as generating a function that quantitatively represents distribution information of the representation vectors. The same applies to identifying the reference distribution. The generated function regarding the distribution may be recorded in the second memory 240.

For example, the data distribution of the low-dimensional representation vectors may be represented in the form of a probability density function (PDF) or a probability mass function (PMF). In addition, by using kernel density estimation (KDE), the data distribution of the low-dimensional representation vectors may be expressed as a continuous probability distribution, or by using a probability mass function (PMF) such as a histogram, the target distribution may be expressed as a discrete probability distribution.

In particular, although the data distribution of the low-dimensional representation vectors may be provided as a single piece of information, the target distribution may also be provided in a scalable manner by selectively providing multi-scale information. For example, information of kernel density estimation or a probability mass function may be represented in a fine or coarse manner, and such features may be used to provide scalable distribution information.

In the case of a data distribution obtained using kernel density estimation (KDE), when the bandwidth is set to a small value, the KDE reflects more detailed variations of the data, resulting in a fine representation. Conversely, when the bandwidth is set to a large value, the KDE expands the data more smoothly over a wider range, resulting in a coarse representation. Accordingly, the dimension-reduced representation vectors may be selectively provided as data distribution information in a multiscale manner by representing the KDE using multiple bandwidth values. In this case, KDEs generated by applying different bandwidth values may be transmitted, and by combining these KDEs, data distribution information at multiple scales may be represented. For example, when two KDE results are transmitted—one using a bandwidth for fine representation and the other using a bandwidth for coarse representation—their overlay may simultaneously represent both the detailed features and the overall trend of the data distribution of the low-dimensional representation vectors.

A PMF may also be used to generate and transmit multiscale data distributions for the dimension-reduced representation vectors. To represent the data distribution in a scalable manner using a PMF, the granularity of the distribution may be adjusted by changing the size of the bins, thereby expressing either a fine or coarse representation. A PMF generally represents the probability of each bin for discrete data, and the degree of fineness or coarseness of the data distribution may vary depending on the bin size. Accordingly, a multiscale representation may be achieved using a PMF by computing distributions for multiple bin configurations and transmitting them, thereby enabling multiscale expression of the data distribution.

The features of the target distribution do not necessarily need to be determined by the first device 100, and may instead be determined by the second device 200. In this case, the first device 100 may provide the target data set to the second device 200 so that the second device 200 can determine the features of the target distribution.

S220 corresponds to a step of performing the first function, in which the first device 100 trains the analysis model by using sample data obtained through data sampling based on the information of the target distribution received in S210, and then provides (transmits) the trained analysis model to the second device 200.

That is, the first controller 150 may control sampling of sample data that conforms to the information of the target distribution received in S210 from the reference data set input as input data, may control training of the analysis model by using the sampled data, and may control transmission of the trained analysis model to the second device 200 through the first communicator 120. Accordingly, the second controller 250 may control receiving the analysis model through the second communicator 220 and storing the received analysis model in the second memory 240.

There are cases where the reference distribution is not used (hereinafter referred to as the “first case”) and cases where the reference distribution is additionally used (hereinafter referred to as the “second case”).

Data sampling performed in S220 is a process of selecting appropriate reference data as sample data from the reference data set input as input data, with reference to the target distribution. For example, among the reference data included in a reference data set having 1,000 items, an arbitrary number, such as 100 items, may be selected as sample data so as to follow the target distribution. Alternatively, when the entire reference data set is regarded as 100%, reference data may be selected as sample data in an arbitrary proportion so as to follow the target distribution.

That is, when the reference data set is input, reference data may be selected and sampled from the reference data set so as to correspond to the target distribution of the target data set (that is, to conform to statistical features of the target distribution), and, accordingly, reference data that follow the target distribution (that is, that conform to statistical features of the target distribution) may be output as sample data. As a result, the sample data constitute a data set sampled from the reference data of the entire reference data set so as to have the data distribution of the target distribution.

For example, the target distribution may be a uniform distribution, and the reference distribution may be a Gaussian distribution. In this case, reference data may be selected and sampled from the reference data set so as to follow the uniform distribution, and, accordingly, the sample data may have the uniform distribution rather than the Gaussian distribution. As a result, the sample data may constitute a data set sampled from the reference data of the entire reference data set so as to have the data distribution according to the reference distribution of the target data set.

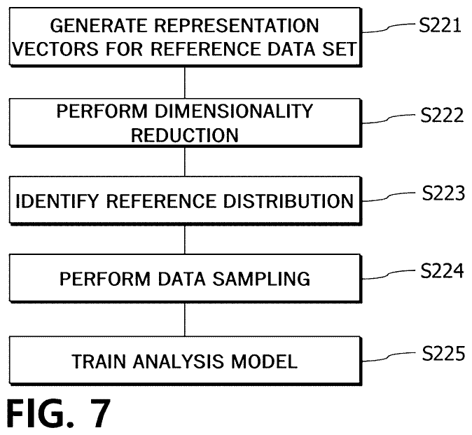

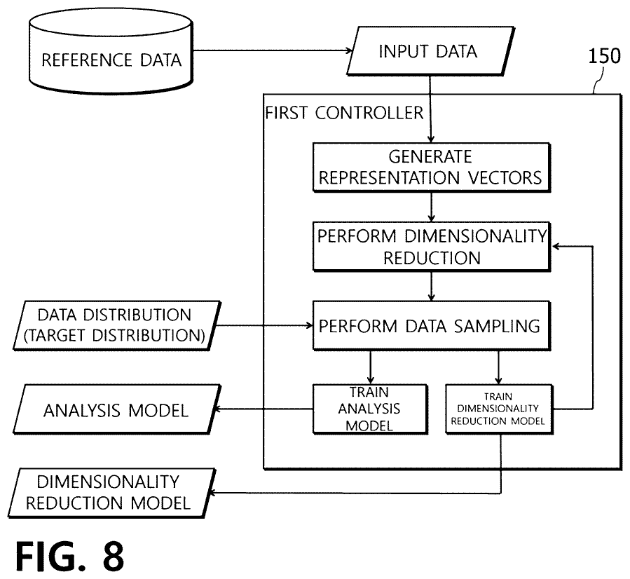

FIG. 7 illustrates a detailed flowchart for S220 and FIG. 8 illustrates a conceptual diagram of processing performed by the first controller 150 of the first device 100.

Referring to FIG. 7, S220 may include S221 to S225. Of course, referring to FIG. 8, S221 through S225 may be performed by the first controller 150. That is, the processor of the first controller 150 may process the execution of S221 to S225.

S221 is a step of generating representation vectors for the reference data set.

That is, the first controller 150 may control the generation of a representation vector for each reference data of the reference data set. The controller 150 may utilize various embedding models to generate the representation vectors. For example, the embedding model may be a model trained using various techniques such as an autoencoder, Word2Vec, GloVe, FastText, BERT, Doc2Vec, a CNN, CLIP, a Transformer, or a Vision Transformer.

In this case, it is preferable that the first controller 150 generate representation vectors for the reference data set in the same manner as the manner used in S211 to generate representation vectors for the target data set. This is because only in such a case can subsequent dimensionality reduction, data distribution identification, and data sampling be performed.

S222 is a step of performing dimensionality reduction.

That is, the first controller 150 may control the reduction of the dimension of the representation vectors of the reference data set, which are generated in S221, to lower dimensions. In this case, dimensionality reduction for each representation vector may be performed using only a linear method, only a nonlinear method, or a combination of both a linear method and a nonlinear method. However, since the linear method or nonlinear method described above is the same as those described in S212, detailed descriptions thereof will be omitted below.

In particular, the dimensionality reduction model used in S222 for the representation vectors of the reference data (hereinafter, also referred to as the “reference dimensionality reduction model”) may be preferably the same model as the dimensionality reduction model used in S212 for the representation vectors of the target data (that is, the target dimensionality reduction model). That is, it may be preferable that the same dimensionality reduction model used as the reference dimensionality reduction model in S222 be reused as the target dimensionality reduction model.

This is because data distribution analysis and data sampling can be performed only when dimensionality reduction is carried out on the representation vectors of the target data set and the reference data set using the same type of dimensionality reduction model. In addition, when performing dimensionality reduction on representation vectors, even when a model such as PCA is used, a significant amount of computation is required to identify eigenvectors and eigenvalues. However, when the same dimensionality reduction model such as PCA is used in S212 and S222, the eigenvectors and eigenvalues computed for the reference data set in S222 can be directly reused in S212 without additional computation, thereby allowing the corresponding computation process to be omitted in S212. Accordingly, S212 can be performed more rapidly and efficiently.

However, such a dimensionality reduction model may be preferably prepared (i.e., trained) in advance and transmitted to the first device 100 before S210 is performed. To this end, the target dimensionality reduction model may be prepared in advance and transmitted to the first device 100 before S212 is performed.

Meanwhile, the reference dimensionality reduction model used in S222 may be a linear model or a nonlinear model. Of course, such a reference dimensionality reduction model includes the same parameters as those of the target dimensionality reduction model. In this case, the parameters of the reference dimensionality reduction model may be trained using a data set implemented as representation vectors of the reference data set in S220.

For example, representation vectors (embedding vectors) may be obtained by passing 1,000 reference data items through a neural network configured to compute representation vectors, and PCA may then be performed on the obtained representation vectors to select parameters (i.e., eigenvector and eigenvalue information) of 100 dimensions (the dimensionality may vary) as the reference dimensionality reduction model. Alternatively, a UMAP-based model configured to reduce the representation vectors of the 1,000 reference data items into three dimensions may be trained as the reference dimensionality reduction model.

In the present method, in addition to a standalone usage scheme, a reference dimensionality reduction model may be constructed by combining a linear model and a nonlinear model in consideration of computational efficiency. For example, a linear model may be applied first to reduce the dimensionality to a certain extent, and a nonlinear model may then be successively applied to further reduce the dimensionality. In this case, however, the linear model and the nonlinear model need to be sequentially trained in accordance with such an application order. This will be described in detail through a specific example as follows.

For example, when 1,000-dimensional data (i.e., representation vectors) are first reduced to 100 dimensions using PCA and then further reduced to three dimensions using UMAP, the UMAP model is trained based not on the original 1,000-dimensional data but on the 100-dimensional data reduced by PCA. Accordingly, the UMAP model learns only a transformation from 100 dimensions to three dimensions, and thus produces results different from those obtained when dimensionality is directly reduced from 1,000 dimensions to three dimensions. In summary, when the process proceeds as 1,000 dimensions (representation vectors of target data)→PCA (100 dimensions)→UMAP (3 dimensions), the UMAP model is trained to reduce the 100-dimensional data to three dimensions.

S223 is a step of identifying information on a reference distribution.

That is, the first controller 150 may control identifying information on a data distribution (i.e., a reference distribution) of representation vectors that are dimensionally reduced (i.e., low-dimensional) with respect to the reference data set. However, since the data distribution information of the reference distribution is the same as that described above with respect to the data distribution information of the target distribution in S213, a detailed description thereof will be omitted below.

However, in the present method, S223 of identifying information on the reference distribution may be performed selectively. That is, S223 may be performed only in the second case, and S223 may be omitted in the first case.

In particular, in S213 or S223, by calculating a data distribution of the low-dimensional representation vectors, processing speed for data sampling in terms of computational load in S224 can be improved, the amount of data transmitted to another device can be minimized in terms of data transmission, and data security can be enhanced in terms of security.

For example, in terms of data transmission, when the number of target data items is 1,000, information on dimensionally reduced representation vectors corresponding to the 1,000 target data items needs to be transmitted from the second device 100 to the first device 100. However, in such a case, the amount of transmitted data increases in proportion to the number of target data items, and the size of the first memory 140 required to temporarily store the transmitted data also increases.

Accordingly, in the present method, by sharing only information on a data distribution of the dimensionally reduced representation vectors of the target data set (i.e., a target distribution), the entire set of the dimensionally reduced representation vectors need not be mutually shared. In addition, in terms of security, since the dimensionally reduced representation vectors are not directly shared between the first device 100 and the second device 200, sensitive considerations related to data sharing can be alleviated.

In particular, it may be preferable that a representation format of the reference distribution information in S223 be the same as a representation format of the target distribution information in S213. This is because only when the target distribution information and the reference distribution information are expressed in the same format, data sampling therefrom can be performed.

S224 is a step of performing data sampling.

That is, the first controller 150 may control selecting, from among representation vectors of the entire reference data set that have been dimensionally reduced, representation vectors that follow the target distribution prepared in S210 and stored in advance in the first memory 140, and may control sampling data corresponding to the selected representation vectors as sample data. Accordingly, sample data including reference data corresponding to the representation vectors selected through the sampling (i.e., a sample data set) may be output. In this case, in the second case, the first controller 150 may perform the data sampling by additionally using information on the reference distribution identified in S223.

### First Case: Data Sampling Based on a Target Distribution for Dimensionally Reduced Representation Vectors of a Reference Data Set

In the first case, the first controller 150 performs data sampling with reference to information on the target distribution. When the target distribution is given in the form of KDE or PMF, data sampling according to the corresponding distribution form may be performed as follows.

### KDE-Based Data Sampling

A process of sampling M sample data items (where M is a natural number greater than or equal to 2) based on KDE is as follows. However, since KDE is represented as a function, a desired number of sample data items can be sampled through inverse transform sampling or rejection sampling.

### 1. Preparing a KDE-Based Density Function:

That is, a probability density function calculated using KDE is prepared. In this case, the probability density function may represent a probability density at a specific location.

### 2. Inverse Transform Sampling or Rejection Sampling:

Since KDE represents a continuous probability density, sampling from the reference data set can be performed by applying inverse transform sampling or rejection sampling to the corresponding probability density function.
Rejection sampling is a method in which points are randomly selected within a defined sampling range, and sampling is determined by comparing a probability density value at each selected point. In this case, a selected point may be accepted only when the probability density value of the selected point is lower than a value of the KDE-based density function.

### KMF-Based Data Sampling

A process of sampling M sample data items based on PMF is as follows. However, since PMF represents a discrete probability distribution, sample data may be sampled based on probability values of respective bins in a given dimensionally reduced space.

### 1. Preparation of PMF-Based Data:

A histogram (bins) based on a PMF and probability values for respective bins are prepared.
In this case, the probability values of the respective bins are normalized such that a total probability mass becomes 1.

### 2. Generation of a Cumulative Distribution Function (CDF):

A cumulative distribution function (CDF) is generated by cumulatively summing the probabilities of the respective bins of the PMF (wherein the CDF may be used to determine a probability of selecting a specific bin during sampling).

### 3. Sampling:

Generate a random variable U following a uniform distribution in a range of [0, 1].
Identify a bin corresponding to the random variable U. This corresponds to determining a bin in which the value U falls within a corresponding interval of the cumulative distribution function (CDF).
Generate sample data at a center of the selected bin or at a random position within the selected bin.
Repeat the above process M times to obtain M sample data items.

### First Case: Multi-Scale Data Sampling Based on a Target Distribution for Dimensionally Reduced Representation Vectors of a Reference Data Set

In the case of the target distribution, information on the data distribution may be provided in a multiscale manner. In this case, data sampling may be performed, depending on a scale, by using only coarse distribution information, by using fine-grained distribution information, or by using a combination of two or more pieces of multiscale distribution information.

In this case, data sampling may be performed while allowing the reference data set to follow statistical characteristics that conform to the target distribution and while controlling variations in data features according to scale. For example, when the method related to S220 is deployed in the first device 100, such as an edge computer or a mobile terminal, the first device 100 may be utilized as a training data acquisition device for transfer learning, domain adaptation learning, federated learning, or the like.

### Second Case: Data Sampling Based on a Target Distribution After Identifying the Target Distribution for Dimensionally Reduced Representation Vectors of a Reference Data Set

According to the second case, when a data distribution for the dimensionally reduced representation vectors of the reference data set (i.e., a reference distribution) is identified, a data sampling scheme that is further extended compared to that of the first case may be provided.

That is, by comparing two data distributions (i.e., a reference distribution and a target distribution), at least one region among first to third regions may be identified, and then sampling may be performed for the identified region. In this case, the first region is a region in which reference data and target data overlap when the two data distributions are compared (i.e., a region in which the corresponding data overlap in a number greater than or equal to a predetermined number). The second region is a region in which, when the two data distributions are compared, only target data exist in a number greater than or equal to a predetermined number without reference data, or target data exist at a ratio greater than or equal to a predetermined ratio relative to reference data (i.e., a non-overlapping region). In addition, the third region is a region in which, when the two data distributions are compared, only reference data exist in a number greater than or equal to a predetermined number without target data, or reference data exist at a ratio greater than or equal to a predetermined ratio relative to target data (i.e., a non-overlapping region). After identifying at least one region among the first to third regions, sampling may be performed for the first region, the second region, or the third region. In particular, it may be preferable to perform sampling for the second region.

For example, in the case of domain adaptation learning, a model may be adapted by performing sampling from the first region, the second region, or the third region in order to understand and adjust differences between different domains. In the case of anomaly detection, sampling may be performed from the first region, the second region, or the third region to determine whether data that are rare in one distribution predominantly appear in another distribution. From the perspective of improving model performance, when training data are insufficient only in a specific region, the model may be supplemented by sampling from a non-overlapping second region or third region.

As an example of sampling from the first region, the second region, or the third region, in order to perform sampling from a specific region based on KDEs or PMFs of two data distributions (i.e., a reference distribution and a target distribution), the following procedure may be followed.

### 1. Calculation of Density Differences Between Two Data Distributions

First, KDEs or PMFs of the two data distributions are calculated, and density values are compared in the same coordinate space to distinguish the first region, the second region, and the third region based on differences in density.

For example, if density functions of two data distributions P and Q are denoted as fP(x) and fQ(x), respectively, the first region, which is an overlapping region, may be defined as min(fP(x), fQ(x)). Here, min(A, B) denotes an operation that outputs a minimum value between A and B. The second region, which is a new region that exists primarily in P but scarcely in Q, is a region in which fP(x)−fQ(x)>0, that is, a region having a positive difference. Conversely, the third region, which exists in Q but scarcely in P, is a region in which fP(x)−fQ(x)<0, that is, a region having a negative difference. For reference, by using the min function to identify overlapping regions, only regions in which both data distributions have high values are retained, thereby allowing a common region to be identified in a stable manner.

For example, when fP(x) has a high probability density and fQ(x) has a low probability density at a specific point, applying the min operation causes this point to output the lower fQ(x) value. In contrast, when both fP(x) and fQ(x) have high probability densities, the min operation still outputs a relatively large value. As a result, by performing min(fP(x), fQ(x)) on fP(x) and fQ(x), only portions in which both distributions commonly have high probability densities remain, while regions in which one distribution has a low value are effectively excluded.

### 2. Sampling in Each Region

Sampling is performed based on the previously identified regions in accordance with a user's purpose and intention. For example, sampling in the first region, which is an overlapping region, may be performed by identifying the first region using information of min(fP(x), fQ(x)) and then performing sampling. Sampling in the second region or the third region, which corresponds to newly appearing regions or missing regions, may be performed by calculating fP(x)−fQ(x), identifying the corresponding region, and then performing sampling. In particular, it may be preferable to perform sampling for the second region.

### Second Case: Multi-Scale Data Sampling Based on a Target Distribution After Identifying the Target Distribution for Dimensionally Reduced Representation Vectors of a Reference Data Set

The description provided above may also be applied to a case in which data sampling is extended to a multiscale manner. That is, the reference distribution and the target distribution may each have distribution information at multiple scales, and sampling may be performed by comparing the distributions at a desired scale.

S225 is a step of training the analysis model by using the sample data set and providing (i.e., transmitting) the trained analysis model to the second device 200.

That is, the first controller 150 controls training of the analysis model to be performed according to a machine learning technique based on the sample data sampled in S224. In this case, the training may be prior training of the analysis model using the sample data, or retraining of an analysis model that has already undergone prior training by using the sample data.

Of course, in the case of supervised learning, training data (or retraining data) may be implemented by including sample data as input data and including result data, which are output data corresponding to the input data, thereby forming pairs of the input data and the output data. Accordingly, training (prior training or retraining) of the analysis model may be performed by using the training data. In this case, the output data may be selected from output data already included in the reference data and used accordingly.

As described above, the trained analysis model may be provided (i.e., transmitted) to the second device 200. That is, the first controller 150 may control storing, in the first memory 140, the analysis model trained based on the sample data and transmitting the trained analysis model to the second device 200 through the first communicator 120. Accordingly, the second controller 250 may control receiving the analysis model through the second communicator 220 and storing the received analysis model in the second memory 240.

S230 is a step of performing the second function, in which the second device 200 performs inference (i.e., analysis) on target data by using the analysis model.

That is, the second controller 250 may control obtaining output data (i.e., analysis data), which are results (i.e., analysis results) of inference (i.e., analysis) on the target data, by inputting the target data into the analysis model trained and received in S225. For example, analysis performed by the second device 200 may include classification, regression, clustering, anomaly detection, recommendation, association analysis, sequential pattern analysis, or time-series analysis, but is not limited thereto.

In particular, the target data used in S210 and S220 described above may be data that have previously been used for inference (i.e., analysis) in the second device 200, and may have been collected over a predetermined period of time or in a quantity equal to or greater than a predetermined number. Accordingly, the present disclosure is capable of responding to data drift that appears based on the previous target data.

However, the target data input to the analysis model in S230 may preferably be new target data rather than target data included in the target data set used during performance of S210 and S220. That is, inference (i.e., analysis) on the new target data may be performed in S230.

Of course, the second controller 250 may collect the new target data over a predetermined period of time or in a quantity equal to or greater than a predetermined number, and S210 and S220 described above may be repeatedly performed based on the collected new target data. Through such repeated performance, the present disclosure is capable of responding to data drift that appears due to the new target data.

Meanwhile, in the present disclosure, the second device 200 may be an electronic device having relatively low computational processing capability, such as an edge computer or a mobile terminal, and may correspond to an electronic device in which performance of computational resources such as a CPU, memory, or GPU is highly limited for performing training of an analysis model on its own, or in which it is difficult to directly perform training of the analysis model due to use of auxiliary power such as a battery.

In contrast, the first device 100 may correspond to an electronic device having relatively higher computational processing capability than the second device 200. Accordingly, training of the analysis model, which is difficult to perform in the second device 200 having low computational processing capability, may be performed in the first device 100 having higher computational processing capability.

In particular, the first device 100 samples sample data based on information of a target distribution received from the second device 200 to improve the performance of an analysis processing task of the second device 200, trains an analysis model using the sampled data, and then provides the trained analysis model to the second device 200.

Of course, a plurality of second devices 200 may be present. For example, when the first device 100 has sufficient computational capability, the first device 100 may respond to training requests for respective analysis models from a plurality of second devices 200. In addition, even when requests for analysis models are continuously received over time, the first device 100 may sample sample data based on information of respective target distributions received from the plurality of second devices 200 and train respective analysis models, thereby providing the trained analysis models to the plurality of second devices 200.

As described above, the present disclosure configured as such has an advantage in that it is capable of providing and utilizing a machine learning model trained based on features of an analysis data source. That is, the present disclosure enables a model suitable for an actual service environment to be trained, provided, and utilized by using features of analysis data sources generated in the actual service environment (i.e., data distribution information of target data), thereby providing an advantage of effectively responding to data drift.

In addition, the present disclosure identifies a data distribution based on representation vectors and dimensionality reduction for each data set, and then trains a model by using new training data sampled in correspondence with the data distribution of the target data set. Accordingly, the present disclosure is capable of responding to data drift with a reduced amount of computation, and thus provides an advantage in that it can be processed even by a computer having relatively low computational processing capability.

In particular, the present disclosure has an advantage in that it is capable of responding while reflecting privacy protection issues (i.e., a first issue) and issues related to differences in source features between reference data and target data (i.e., a second issue). That is, in order to respond while reflecting the first issue and the second issue, the second device 200 may share only limited information about an analysis data source (i.e., target data) with the first device 100, thereby improving analysis performance for the target data.

For example, with regard to the first issue, from the perspective of personal data protection, when the second device 200 is a mobile terminal and the target data are photographs including faces stored in the mobile terminal, it is preferable that such photographs are not transmitted to the first device 100 and are not used for training an analysis model that is a face recognizer. Accordingly, in the present disclosure, instead of transmitting the target data corresponding to the face photographs from the second device 200 to the first device 100, only information of a data distribution of the target data (i.e., a target distribution) is transmitted from the second device 200 to the first device 100, thereby enabling protection of personal information related to the face photographs.

In addition, with regard to the second issue, reference data and target data have differences in source features. For example, the target data are highly likely to be data that do not include ground-truth labels, whereas the reference data are raw data that include ground-truth labels. In this case, even if the first device 100 is able to directly access the target data, there are constraints on directly using the target data for training. Accordingly, in the present disclosure, instead of directly using the target data to train the analysis model, the analysis model is trained by using sample data sampled based on information of a data distribution of the target data (i.e., a target distribution). As a result, training reflecting features of the reference data can be achieved despite differences in source features between the reference data and the target data.

While the present disclosure has been described in detail with reference to representative embodiments, it will be understood by those skilled in the art that various modifications and equivalent other embodiments may be possible based on the present disclosure. Accordingly, the true technical scope of the present disclosure should be defined by the spirit of the appended claims.

What is claimed is:

1. A method performed in a system comprising at least one memory and at least one processor, the method comprising:
determining a target distribution for a target data set, wherein the target distribution represents data distribution features of the target data set;
determining a sample data set sampled from a reference data set based on the target distribution;
performing training of an analysis model based on the sample data set; and
storing the trained analysis model in the memory.

2. The method of claim 1, wherein the system comprises a first device and a second device, and wherein the method further comprises:
determining, by the first device, the target distribution and providing distribution features determined thereby to the second device; and
training, by the second device, the analysis model based on the target distribution, and providing the trained analysis model stored therein to the first device.

3. The method of claim 2, wherein the first device has relatively higher computational processing capability than the second device.

4. The method of claim 2, wherein the determining the target distribution comprises:
generating a representation vector for each target data item;
reducing a dimensionality of each generated representation vector; and
identifying the target distribution using the dimensionally reduced representation vectors.

5. The method of claim 2, wherein the executing training of the analysis model comprises:
generating a representation vector for each reference data item;
reducing a dimension of each generated representation vector by using a reference dimensionality reduction model; and
sampling data corresponding to selected representation vectors among the dimensionally reduced representation vectors as the sample data.

6. The method of claim 5, wherein the executing training of the analysis model further comprises:
identifying a reference distribution, which is a data distribution of the reference data set, by using each of the dimensionally reduced representation vectors; and
sampling the sample data based on a comparison between the identified reference distribution and the prepared target distribution.

7. The method of claim 5, wherein the determining the target distribution comprises:
generating a representation vector for each target data item; and
reducing a dimension of each generated representation vector by using a target dimensionality reduction model, and identifying the target distribution by using each of the dimensionally reduced representation vectors, and
wherein the target dimensionality reduction model and the reference dimensionality reduction model have identical parameters.

8. The method of claim 7, further comprising transmitting, by the first device, the target dimensionality reduction model to the second device,
wherein the reference dimensionality reduction model reuses the target dimensionality reduction model.

9. The method of claim 7, wherein the target dimensionality reduction model and the reference dimensionality reduction model are implemented using a linear method or a nonlinear method, or are implemented using a combination of a linear method and a nonlinear method.

10. The method of claim 1, wherein the target distribution is expressed in the form of a probability density function (PDF) or a probability mass function (PMF).

11. The method of claim 6, wherein the reference distribution and the target distribution are each expressed in the same form.

12. The method of claim 5, wherein the sampling comprises:
preparing a probability density function for the target distribution based on kernel density estimation (KDE); and
sampling the sample data from the probability density function using inverse transform sampling or rejection sampling.

13. The method of claim 5, wherein the sampling comprises:
preparing a histogram and probability values for respective bins based on a probability mass function (PMF);
generating a cumulative distribution function (CDF) by cumulatively summing the probability values of the respective bins of the PMF; and
sampling the sample data at a center position or a random position within a bin corresponding to a random variable generated according to a uniform distribution from the CDF.

14. The method of claim 6, wherein the sampling comprises:
comparing the reference distribution and the target distribution to identify a region in which only reference data exist in a number equal to or greater than a predetermined number, or in which target data exist at a ratio equal to or greater than a predetermined ratio relative to the reference data; and
sampling the sample data from the identified region.

15. An apparatus, comprising:
at least one memory storing a plurality of instructions and an analysis model; and
a processor configured to execute the plurality of instructions to:
determine a target distribution for a target data set, the target distribution being data distribution features of the target data set;
determine a sample data set sampled from a reference data set based on the target distribution;
execute training of the analysis model based on the sample data set; and
store the trained analysis model in the memory.

16. The apparatus of claim 15, wherein, during the training, the processor is configured to:
generate a representation vector for each reference data item;
reduce a dimension of each generated representation vector; and
sample, as the sample data, data corresponding to selected representation vectors among the dimensionally reduced representation vectors.

17. The apparatus of claim 16, wherein, during the sampling, the processor is configured to:
prepare a probability density function for the target distribution based on kernel density estimation (KDE); and
perform sampling of the sample data from the probability density function by using inverse transform sampling or rejection sampling.

18. The apparatus of claim 16, wherein, during the sampling, the processor is configured to:
prepare a histogram and probability values for respective bins based on a probability mass function (PMF);
generate a cumulative distribution function (CDF) by cumulatively summing the probability values of the respective bins of the PMF; and
perform sampling of the sample data at a center position or a random position within a bin corresponding to a random variable generated according to a uniform distribution from the CDF.

19. The apparatus of claim 15, wherein, during the sampling, the processor is configured to:
identify a reference distribution, which is a data distribution of the reference data set, by using each dimensionally reduced representation vector;
identify, by comparing the identified reference distribution with the target distribution, a region in which either reference data exist in a number greater than or equal to a predetermined number without corresponding target data, or target data exist at a ratio greater than or equal to a predetermined ratio relative to the reference data; and
perform sampling of the sample data from the identified region.

20. A system, comprising:
a first device comprising a first memory and a first processor; and
a second device comprising a second memory and a second processor,
wherein the first device is configured to:
determine a target distribution for a target data set and store the determined target distribution in the first memory, the target distribution being data distribution features of the target data set; and
provide the determined target distribution to the second device; and
wherein the second device is configured to:
determine a sample data set sampled from a reference data set based on the target distribution;
execute training of the analysis model based on the sample data set; and
provide the trained analysis model to the first device.
